(19) United States
(12) Patent Application Publication
(10) Pub. No.: US 2012/0329026 A1
(43) Pub. Date: Dec. 27, 2012

(54) SYSTEMS AND METHODS FOR PROVIDING LEARNERS WITH AN ALTERNATIVE TO A TEXTBOOK OR SIMILAR EDUCATIONAL MATERIAL

(76) Inventor: Bruce Lewolt, Newbury Park, CA (US)

(21) Appl. No.: 13/531,460

(22) Filed: Jun. 22, 2012

Related U.S. Application Data
(60) Provisional application No. 61/501,217, filed on Jun. 25, 2011.

(51) Int. Cl. G09B 5/00

(52) U.S. Cl. 434/322

(57) ABSTRACT

System and method for providing new educational material to one or more learners comprising analyzing the words or images used in one or more items of original educational material to determine the topics covered in the original educational material, identifying the topics covered in the original educational material, identifying the order in which the topics are presented in the original educational material, creating a list of the topics covered in the original educational material and the order in which they are presented, searching available databases and publically known sources for content on the topics covered in the original educational material, compiling the content on the topics covered in the original educational material to create a new educational material that covers the topics of the original educational material and providing or providing access to the new educational material to one or more learners.

### BACKGROUND OF THE INVENTION

1. Related Application

The present application is related to and claims priority to U.S. Provisional Patent Application No. 61/501,217 filed on Jun. 25, 2011, the entire contents of which are incorporated herewith by reference.

2. Field of the Disclosure

The present disclosure generally relates to systems and methods for providing learners with an alternative to a textbook or similar educational material. The present disclosure more specifically relates to systems and methods of content creation providing new educational material.

### GENERAL BACKGROUND

Traditionally the textbooks provided to one or more individuals have specific information regarding a particular topic and can be expensive. This limits the individuals learning ability to learn to the specific format, style and content of the textbook. Accordingly, there exists a need for an alternative to textbooks and other learning materials.

Providing alternatives to purchasing a required or recommended textbook have been around for years. They come in the form of another textbook on the same subject or a general book that covers the subject in a summary way. Example of the former include a textbook by another publisher, examples of the later include general subject books produced cliffnotes™ and SparkNotes™ or online resources. The problem with using currently existing alternatives to a specific textbook is that it is likely that the student who uses the alternative may never learn some of the critical concepts and facts from the original textbook that the professor selects to include on a test. The content of the alternative textbook can be different, the format can be different, it can be costly and the content can be presented in a way that is not ideal for the learners as a group or individually. Therefore the student who uses the alternative is often at a disadvantage to the student who uses the original textbook.

Study guides are also well known in the marketplace. Unfortunately study guides still require the student to purchase the original textbook to learn the content that they will use the study guide to study. Of course a student could choose to just purchase the study guide but they would then be at a significant disadvantage because the study guide does not include important concept and facts covered in the textbook and is not intended to be a replacement of substitute for the textbook. In addition it is very difficult to learn difficult or complicated concepts from a study guide. These factors once again put the student at a disadvantage over the student who uses the original textbook and provides textbook publishers with almost a monopoly for the needed textbook.

This monopolistic control over student purchasing or using decisions is clear to see in higher education where students are forced to either purchase the book selected by their professor or be at a significant disadvantage. They have no choice in the selection process and no alternative to an expensive textbook. In the last 20 years textbook publishers have exploited this lack of market choice by raising the price of their textbooks at a rate that far exceeds inflation. The result is an unfair economic burden on students and their families.

In addition to the ease at which publishers can raise the price of textbooks there is very little incentive on publishers to raise the quality of the textbook in a way that improves learning outcomes or reduces the tedious nature of studying. Since it is the professor who chooses the textbook, the professor tends to base their choice on what is best for the professor. This is often a book provided by a publisher who provides the professor with various benefits or bribes (e.g., royalties, free books, free PowerPoint lecture slides and test banks full of test questions that professors can use instead of writing their own questions).

The negative effects of this lack of competitive pressure on textbook publishers is easy to see if one compares the advances of personal computing devices over the last 15 years to the advances in textbooks. Computing devices have gone from bulky laptops with dim screens to devices like the iPad. At the same time if one looks at a Freshman American history textbook of 15 years ago and one on the market today, for the most part, the only noticeable difference will be the increased price.

One other option that has failed to gain wide usage, at the time of this disclosure is the open source textbook. Open source textbooks are wholly new creations and not replacements for a specific textbook. If a student chooses to use an open source textbook instead of the required textbook they would experience the same disadvantages as listed previously herein. It is worth mentioning that despite lots of publicity, open source textbooks have failed to be successful because they can't overcome the problem of professor acceptance and do not provide the same content/information as the original book. If the professor doesn't accept and choose the open source textbook and there are no quality control measures in please, it is unlikely that is will be used by the students. On the other hand, the textbook replacement doesn't require professor acceptance because it replaces a textbook that the professor has already selected.

Providing a replacement textbook requires overcoming various obstacles and challenges. Even without the added functions in this disclosure that improve learning effectiveness or the other numerous benefits and advantages discussed herein, rewriting the same content would likely violate copyright and possibly other intellectual property laws. Additionally, the total cost of creating a textbook from scratch is astronomical. No new player could possible hope to compete with the major publishers who have already accumulated huge infrastructures and the have the ability to rely on constant revisions of existing textbooks instead of creating new textbooks from scratch. This is why the textbook industry is one of the only multibillion dollar industries in the United States where not a single major competitor has emerged in the last 25 years. That is why textbook publishers maintain the exclusive rights to profit from these items when it comes to the sale of textbooks. To be successful as a method of providing students with a learning material the method must also include a method for dramatically reducing the cost of producing the replacement textbook or other learning material, which the method and systems of the present disclosure do.

A method of lowering costs that incorporates the method and process disclosed in the present application would have been impossible to conceive without the benefit of research done by the inventor. Prior to his research it was thought that the most important component of the process the human brain uses to grow the connections that produce mastery was the initial learning experience. Therefore great amounts of money were spent on graphics and writers to do the best possible job of explaining the content. This part of the learning process is called initial understanding. Initial understanding is somewhat like a photograph or film strip in the brain. The brain can call the photograph up into conscious thought but in and of itself this is not very useful. In order to effectively use the information—a process called adaptive reasoning ability—the human brain must grow thousand and in some cases millions of new connections. This process takes days at best and in most cases weeks. The process only happens if the brain receives the right amount of stimulation to cause the brain to grow the connections. The stimulation must force the brain to recall and use the information and is therefore called Memory Reactivation. This is what a student does when they study using flashcards or reviewing their notes. What the inventor was able to prove is that this second process is far more important to overall learning effectiveness. If the quality and effectiveness of this second phase was improved then the need for the most expensive components of the initial understanding phase could be reduced. The author developed just such a process for reducing the cost and increasing the effectiveness of this second stage. By doing so he was able to reduce the need for the most expensive components of test book production. In a recent study done by the Manchester School System in Massachusetts students who used the inventor's method for stimulating the growth of the connections that produce adaptive reasoning ability had retained learning per hour of study rates that were 270% higher than students who just used the printed textbooks.

The problem with sites that provide free content is that students don't have methods for selecting just the lessons they need to learn and then to combine these lessons with effective study material that handles the second step in the learning process. This is because students are very poor judges of what they actually need to learn. For example if a student is getting bad grades on Algebra tests the student is likely to seek out lessons on balancing equations or some other algebraic concepts. It turns out that in many cases they are wrong and the real reason they are getting wrong answers on algebra tests is that they don't know how to properly divide fractions or work with negative numbers. The same thing is true with creating a textbook replacement that is capable of helping students learn a concept in a more effective way then the original textbook. The system provides additional benefit to the learner if the system can accurately identify the pre-requisite knowledge for the material that is about to be taught in a section of a textbook and then identify any gaps in that pre-requisite knowledge that a specific student has. The system should further be able to select the right lesson content to teach them this knowledge before moving the student forward to learn the concept covered in the specific section of the textbook. If free online lessons are going to be incorporated into a textbook alternative, the method must include a way to select the right lesson to fill each prerequisite knowledge gap that a student has.

There exists a need to break the near monopolistic control the current textbook publishers have over the textbook purchases, which has allowed them to increase prices at a rate that far exceeds inflation resulting in an increased cost of education for one or more individuals. There exists a need for providing a system, method and apparatus for providing a learning material that enhances the learning process of one or more individuals by improving the learning outcome and learning efficiency. There also exists a need for providing a system, method and apparatus for providing a learning material that can be presented on any current or future digital or non-digital devices so that it is easily available to everyone. There exists a need to provide a learning material that includes enhancements that make using the digital textbook a better learning experience than using the original textbook. The learning material can provide various additional features that provide the individual with increased learning efficiency and improved learning outcome.

Accordingly, for these and other reasons, there exists a need to provide learner's with an alternative learning material to purchasing the original textbook that provides the same content taught in the same order so the student is not disadvantaged and at the same time improves the learning experience, a method that so dramatically reduces the initial cost of textbook creation that a business can be created with a realistic chance of competing with the major publishers. The present disclosure provides these and other related advantages.

### SUMMARY

In one embodiment of the present disclosure systems and methods for providing learners with an alternative to a textbook or similar educational material is provided as described and claimed herein.

In another embodiment of the present disclosure, systems and methods for learning material content creation process, that enhances the learning process by improving the learning outcome and learning efficiency of one or more individuals.

In yet another embodiment of the present disclosure, the system and method for providing new educational material to the one or more learners comprising 1) analyzing the words or images used in one or more items of original educational material to determine the topics covered in the original educational material 2) identifying the topics covered in the original educational material 3) identifying the order in which the topics are presented in the original educational material 4) creating a list of the topics covered in the original educational material and the order in which they are presented 5) searching available databases and publically known sources for content on the topics covered in the original educational material 6) compiling the content on the topics covered in the original educational material to create a new educational material that covers the topics of the original educational material and 7) providing or providing access to the new educational material to one or more learners wherein characteristics about the one or more learners are used to modify the presentation of the new educational material and to improve the learning experience for the one or more learners.

In an aspect of at least one embodiment of the present disclosure, the system and method for providing new educational material to the one or more learners further comprising receiving from the one or more learners' information regarding the format to present the new educational materials.

In another aspect of at least one embodiment of the present disclosure, the system and method for providing new educational material to the one or more learners further comprising using stored information about the one or more learners to determine the best format to present the new educational materials.

In yet another aspect of at least one embodiment of the present disclosure, the system and method for providing new educational material to the one or more learners wherein the order of topics presented in the new educational material is at least substantially similar to the order of the topics presented in the original educational material.

In yet another aspect of at least one embodiment of the present disclosure, the system and method for providing new educational material to the one or more learners wherein the new educational material is presented as any combination of audio, video, text, charts and images.

In yet another aspect of at least one embodiment of the present disclosure, the system and method for providing new educational material to the one or more learners further comprising creating a list of pre-requisite educational material that the one or more learners should possess in order to understand the new educational material.

In yet another aspect of at least one embodiment of the present disclosure, the system and method for providing new educational material to the one or more learners further comprising assessing the one or more learner's knowledge of the pre-requisite educational material and determining which if any of the pre-requisite educational material to be presented to the one or more learners and presenting the pre-requisite educational material to the one or more learners on various types of devices.

In yet another aspect of at least one embodiment of the present disclosure, the system and method for providing new educational material to the one or more learners further comprising identifying and updating the new educational material the one or more learners learn.

In yet another embodiment of the present disclosure, the system and method for providing new educational material to the one or more learners comprising 1) analyzing the words or images used in one or more items of original educational material to determine the topics covered in the original educational material 2) identifying the topics covered in the original educational material 3) identifying the order in which the topics are presented in the original educational material 4) creating a list of the topics covered in the original educational material and the order in which the topics in the original educational material are presented 5) posting bid requests for creating the new educational material 6) evaluating the bid requests for creating the new educational material and 7) awarding the bid to one or more bidders for creating the new educational material.

In yet another aspect of at least one embodiment of the present disclosure, the system and method for providing new educational material to the one or more learners wherein the bid is evaluated on one or more factors including: time required to complete the job, the experience level of the creator(s) of the educational material, the bid price.

In yet another aspect of at least one embodiment of the present disclosure, the system and method for providing new educational material to the one or more learners wherein the system works on an internet enabled device or networked computers.

In yet another aspect of at least one embodiment of the present disclosure, the system and method for providing new educational material to the one or more learners wherein the internet enabled device or networked computers are connected to servers or main frame computers that contain the various application programs and database programs.

In yet another aspect of at least one embodiment of the present disclosure, the system and method for providing new educational material to the one or more learners wherein the internet enabled device or networked computers is from a group consisting of: desktop computers, laptop computers, netbook, terminal, iPad, tablets, immersive learning devices, virtual reality devices and smartphones.

In yet another embodiment of the present disclosure, systems and methods for providing new educational material to one or more learners are provided. The method includes 1) analyzing the original educational material (words, sentences, images, audio, video, charts) used in one or more original educational materials to determine the topics covered in the original educational material 2) identifying the topics covered in the original educational material 3) creating a list of the topics covered in the original educational material 4) searching available databases and publically known sources for content on the topics covered in the original educational material 5) compiling the content on the topics covered in the original educational material to create a new educational material that covers the topics of the original educational material and 6) providing or providing access to the new educational material to one or more learners wherein the learner can edit or modify the content of the new educational material.

In yet another aspect of at least one embodiment of the present disclosure, system and methods for providing new educational material storing more than one item of content for one or more of the educational materials and then storing the characteristics of each educational material. The characteristic of the educational material include format of the educational material which could be a combination of text document, image, audio or video; the pace and starting point at which the material is presented, like if it starts out easy and provides some background information which is helpful to learners who are new to the topic or is condensed for experienced learners who can comprehend the material quickly, the language of the material for second language learners who would benefit from being exposed to the material both in their native language and the language that they will be expected to use the educational material.

In yet another aspect of at least one embodiment of the present disclosure, systems and methods for providing new educational material to one or more learners determining the most effective new educational material to choose to present to the one or more learners.

In yet another aspect of at least one embodiment of the present disclosure, systems and methods for providing new educational material to one or more learners include sensing the type of device the one or more learners are using and selecting the new educational material to present to the one or more learners on that device.

In yet another aspect of at least one embodiment of the present disclosure, systems and methods for providing new educational material to the one or more learners include using stored information about the learner to determine which content to present to the learner.

In another aspect of at least one embodiment the present disclosure, systems and methods for providing new educational material to the one or more learners, including creating a list of pre-requisite knowledge that the learner should possess in order to understand the pre-requisite educational material and creating pre-requisite educational material to teach the pre-requisite knowledge, is provided.

In yet another aspect of at least one embodiment of the present disclosure, systems and methods for providing new educational material to the one or more learners are provided. The systems and methods include assessing the learner's knowledge of the pre-requisite educational material and determining which if any of the pre-requisite educational material to be presented to the learner and presenting the educational material to the learner on various types of devices.

In yet another aspect of at least one embodiment of the present disclosure, systems and methods for providing new educational material to one or more learners is provided. The method further includes creating a list of topics learned by the learner and providing the learner with access to the list of topics learned by the user.

In yet another aspect of at least one embodiment of the present disclosure, systems and methods for providing new educational material to one or more learners is provided. The method further includes building and updating all the material the learner learns and based on the learner's performance and input, future educational material is presented to the learner.

In yet another embodiment of the present disclosure, systems and methods for providing new educational material to one or more learners are provided. The system includes 1) analyzing the words used in one or more items of original educational material to determine the topics covered in the original educational material 2) identifying the topics covered in the original educational material 3) creating a list of the topics covered in the original educational material 4) posting the bid requests for creating the new educational material on one or more sites 5) evaluating the bid requests for creating the new educational material and 6) awarding the bid to one or more bidders for creating the new educational material wherein the bid is evaluated on one or more factors including but not limited to time required to complete the job, the experience level of the creator(s) of the educational material, the bid price.

In yet another embodiment of the present disclosure, systems and methods of content creation for providing new educational material are provided. The method includes a content registration function, a content analysis function, a content search function, a match function, a new function, a creation/modification function, a content request function, a bid function, a content creation function and a content production and posting function.

In yet another aspect of at least one embodiment of the present disclosure, systems and methods for providing new educational material which is a viable and improved alternative to a specific textbook or similar educational product are provided.

In yet another aspect of at least one embodiment of the present disclosure, systems and methods for providing new educational material with various options and allowing individuals to pick the learning material option that is best for them are provided.

In yet another aspect of at least one embodiment of the present disclosure, systems and methods for providing new educational material that can mold the delivery content of things for example the learner's prior knowledge of the subject and preferred method of receiving instruction are provided.

In yet another aspect of at least one embodiment of the present disclosure, systems and methods for providing new educational material eliminating the need for individuals to engage in the tedious and time consuming process of creative study for example preparing flash cards and outlines are provided.

In yet another aspect of at least one embodiment of the present disclosure, systems and methods for providing new educational material saving the individual's time improving the efficiency of the learning experience are provided.

In yet another aspect of at least one embodiment of the present disclosure, systems and methods for providing new educational material increasing convenience as the learner does not have to carry around books or return or resell the hard copy of the textbook are provided.

In yet another embodiment of the present disclosure, systems and methods for providing new educational material that remembers what the individual has learned and the way the individual first learned it so that even years later if the individual needs to refresh their knowledge of that subject the system is able to access and reteach the material much faster than the individual could on their own if they kept a copy of the textbook are provided.

In yet another aspect of at least one embodiment of the present disclosure, systems and methods for providing new educational material that builds and updates the learning profile of the individual to further improve the learning experience when they use the learning material and determine the best method and scheduling to use for presenting learning material to the learner are provided.

In yet another aspect of at least one embodiment of the present disclosure, systems and methods for providing new educational material based on the understanding the other learning material the individual is currently using and the learning needs of that individual and using this information to build a master learning schedule for each individual instead of the individual trying to manually sync the learning needs of several classes is provided.

In yet another aspect of at least one embodiment of the present disclosure, systems and methods for providing new educational material are provided. The method includes building a study schedule for the learner and contacting the learner on various types of devices when it is time to study and then presenting the new educational material to the one or more learners on various types of devices.

In yet another aspect of at least one embodiment of the present disclosure, systems and methods for providing new educational material that contacts the one or more learner when it is the ideal time for learning and provide small chunks of personalized educational material on any digital or non-digital device is provided.

In yet another aspect of at least one embodiment of the present disclosure, the systems, and methods provide an outline for helping individuals to take notes in class and then combine those notes with the educational material to create a comprehensive learning system.

In yet another aspect of at least one embodiment of the present disclosure, the systems, and methods for providing new educational material uses a personalized cataloging system to keep track of everything the individual has ever learned and identifies when the learner needs to use the information in the catalog again and represents the study material to the learner for re-learning.

In yet another aspect of at least one embodiment of the present disclosure, the systems, and methods for providing new educational material that incorporates all the notes and learning material into a master personal database for current and future reference of the individual.

In yet another aspect of at least one embodiment of the present disclosure, the systems, and methods for providing new educational material using the master personal database to provide outlines for writing papers and to help individuals with future learning needs.

In yet another embodiment of the present disclosure, systems and methods for providing new educational material that allows individuals to share information from their personal database in a way that assists another individual or a group of individuals and to receive content from another individual's personal database or the databases of a group of learners are provided.

In yet another aspect of at least one embodiment of the present disclosure, systems and methods for providing new educational material that connects learners to other learners who are currently using the same educational material or who in the past have used the same educational material in a way that allows the learners to help one another are provided.

In yet another embodiment of the present disclosure, systems and methods for providing new educational material that provides a way for teachers, tutors and administrators to view the work done by an individual or group of individuals so that the teacher, tutor or administrator can provide assistance to the learner or group of learners or to allow the teacher, tutor or administrator to monitor or grade the work of the learners or group of learners are provided.

In yet another aspect of at least one embodiment of the present disclosure, systems and methods for providing new educational material using a content acquisition and creation strategy that reduces the cost of creating the new educational material are provided.

In yet another embodiment of the present disclosure, systems and methods providing new educational material creating a list of pre-requisite knowledge that the learner should possess in order to understand the material, further creating content to teach these pre-requisite items and content to aid the individual in learning these prerequisite items, further using the assessment items to assess an individual's understanding of the pre-requisite items, further using the result of the assessment to determine which if any of the prerequisite content items and study items to be presented to the individual and then presenting those materials to the learner are provided.

In yet another embodiment of the present disclosure, systems, and methods for providing a learning material that creates assessment questions on the material, using the assessment questions to assess the learner's knowledge and delete items from the material that the learner already knows are provided.

In yet another aspect of at least one embodiment of the present disclosure, the individual has the ability to select the level of mastery or grade the learner wishes to achieve for a class and the learner adjusting the amount of studying to meet his goal.

In yet another aspect of at least one embodiment of the present disclosure, the system can analyze the study needs of an individual in two or more courses and combine those needs to develop one master learning and study schedule.

In yet another aspect of at least one embodiment of the present disclosure, the system accumulates a master list of learning material and is capable of reusing content items in multiple textbooks when that same content is taught in two or more textbooks.

In yet another aspect of at least one embodiment of the present disclosure, the system, and method for providing new educational material maintaining a master database of material and reusing it when an item in the master database matches an item on the original content list for another textbook or similar educational product.

In yet another aspect of at least one embodiment of the present disclosure, the systems, and methods for providing new educational material uses learning agents to collect information about the learner and uses this information to improve and personalize the learning experience of the learner.

In yet another aspect of at least one embodiment of the present disclosure, the systems, and methods can present lessons in different ways and test the learner to see what combination of approaches produces the best outcomes.

In yet another embodiment of the present disclosure, the systems and methods have the ability for students to use the database and/or the system to analyze the database and organize data in the database in ways that include but are not limited to ways that benefit the learner, ways that benefit other learners, ways that benefit other groups of learners creating new objects like, but not limited to, outlines for papers.

In yet another embodiment of the present disclosure, the systems and methods for providing new educational material use crowdsourcing to create the learning material in order to dramatically reduce costs.

In yet another aspect of at least one embodiment the present disclosure, a method for providing learners with an alternative to a textbook or similar educational product that a learner can use without being at any disadvantage is provided.

In yet another aspect of at least one embodiment the present disclosure, free or inexpensive online lessons as part of the alternative content in order to dramatically reduce costs.

In yet another aspect of at least one embodiment the present disclosure, systems and methods for providing new educational material at a lower price than the original textbook is provided.

In yet another embodiment of the present disclosure, the content creators, administrators, instructors, and learners can access the components of the system through one or more computing device having internet access. The computing device could be one or more type of computers including but not limited to desktop, laptop, netbook, terminal or device with a processor including but not limited to tablets, and smartphones.

In yet another embodiment of the present disclosure, the connection of the computing devices is to servers or main frame computers that serve similar functions where these computers contain the application programs and database programs.

In yet another embodiment of the present disclosure, the system uses various databases to generate the learning material.

### DRAWINGS

The above-mentioned features and objects of the present disclosure will become more apparent with reference to the following description taken in conjunction with the accompanying drawings wherein:

FIG. 1 shows, in accordance with at least one embodiment of the present disclosure, the block diagram describing the entire project management and content creation process of the application of the system, method and apparatus for the learning material.

FIG. 2 shows, various databases the system uses to generate the learning material. The data stored connected to the application includes but is not limited to the data items shown in the figure. The figure is meant for the purpose of showing various aspects of the present disclosure and does not limit the disclosure to one method of data storage or limit the way a specific category of data is stored or used in relation to another category of data.

FIG. 3 shows, in accordance with at least one embodiment of the present disclosure, the block diagram describing the Content Registration Function of the system and method for the learning material.

FIG. 4A shows, in accordance with at least one embodiment of the present disclosure, the block diagram describing the Content Analysis Function of the original content generated by the system and method for providing the learning material.

FIG. 4B shows, in accordance with at least one embodiment of the present disclosure, the block diagram describing the Content Search Function of the system and method for providing the learning material.

FIG. 5 shows, in accordance with at least one embodiment of the present disclosure, the block diagram describing the Match Function of the application of the system and method for providing the learning material.

FIG. 6 shows, in accordance with at least one embodiment of the present disclosure, the block diagram describing the New Function of the application of the system and method for providing the learning material.

FIG. 7 shows, in accordance with at least one embodiment of the present disclosure, the block diagram describing the Content Request Function of the application of the system and method for providing the learning material.

FIG. 8 shows, in accordance with at least one embodiment of the present disclosure, the block diagram describing the Content Creation Function of the application of the system and method for providing the learning material.

FIG. 9 shows, in accordance with at least one embodiment of the present disclosure, the block diagram describing the Standard Creation or Modification Function of the application of the system and method for providing the learning material.

FIG. 10 shows, in accordance with at least one embodiment of the present disclosure, the block diagram describing the automated content creation Bid Function of the application of the system and method of providing the learning material.

FIG. 11 shows, in accordance with at least one embodiment of the present disclosure, the block diagram describing the Content production and Posting Function of the application of the system and method of providing the learning material.

FIG. 12 shows, in accordance with at least one embodiment of the present disclosure, the block diagram describing the Learning Agent Entry Function of the application of the system and method for providing the learning material.

FIG. 13 shows, in accordance with at least one embodiment of the present disclosure, the block diagram describing the Study Schedule Function of the application of the system and method for providing the learning material.

FIG. 14 shows, in accordance with at least one embodiment of the present disclosure, the block diagram describing the Content Presentation Function of the system and method for providing the learning material.

The above mentioned figures are just one method of performing the present disclosure and other ways can be used to combine functions or reorder functions that produce the same outcome. Therefore the figures are meant to represent one way of producing the present disclosure and not to limit the present disclosure to just the method described in these figures.

### DETAILED DESCRIPTION

The present disclosure is directed to a system, method, and apparatus for providing one or more individuals with new educational material which is a viable or alternative form of the textbook or other learning materials, enhancing the learning process by improving the learning outcome and learning efficiency of one or more learners.

The present disclosure refers to, among other things, a method of providing new educational material that replaces other educational material (e.g., a textbook) however the end product might be marketed under alternative terms that include but are not limited to a book, a comprehensive study guide, a textbook alternative, a textbook clone etc. Regardless of the name, the important components of this method are providing the student with an alternative to purchasing the original learning material (e.g., original textbook) that does not put the student at a disadvantage over students who use the original textbook and provides them with an enhanced learning experience that they could not get from the original textbook.

There are external measurements that claim to measure things and produce reports that can be used to differentiate poor learning material from more effective learning material. One problem with these methods is that there is no way currently for a system to internally verify the results with each individual student. For example, a popular assessment is a Learning Styles assessment. Students take an assessment that claims to identify if the student is an auditory, visual or kinesthetic learner. The teacher or the system then presents visual learners with lessons in the form of videos and auditory learner's lessons in the form of audio and so on. The problem is that there is no internal way to verify that the “visual learner” is actually learning better when she watches a video vs. listening to an audio presentation of the lesson. In the present disclosure the system can present lessons in different ways and tests the learner to see what combination of approaches produces the best outcomes. The characteristics about the one or more learners are used to modify the presentation of the new educational material and to improve the learning experience for the one or more learners. Based on the characteristics of the learning outcomes of one or more learners the educational material is generated tailored to the needs and characteristics of the one or more learners. For internal testing to validate a learning strategy that involves a set of variables to work there has to be a valid way to test learning efficiency and then apply what was learned to future lessons. This does not currently exist and it was only made possible by research done by the inventor into various ways for a system to internally measure increases in learning efficiency involving multiple variables and do so on an individual student basis.

One of the methods is to track how a set of changes affects retained learning per hour of study. For this the system can give the student a test to determine what the student knows about the material covered in the chapter of the textbook or section of a course prior to presenting any instruction. Next the system decides on settings for each of the variables (e.g. The format of the educational material presented, the time of day material is presented, the length of study time between breaks, the amount of studying sessions to be presented to the learner after the initial content has been presented, the days skipped between studying a specific topic, the rate at which the difficulty of study questions can be increased, the level of accuracy a student must achieve in order for the system to determine that the material has been mastered and more) and uses those settings to present the lessons and study material to the learner. Every minute the student spends studying is tracked by the system. This produces a total time that can be presented in hours and fractions of hours. The time can also be allocated by how much time a learner devotes to each topic or even a portion of a topic. Finally, sometime after instruction and studying have been completed by the learner the system gives the learner a post test or someone else administrates a post test the learner and enters information about the evaluation into the system. The difference in the post test and pretest score provides a measurement of what has been learned. This is divided by the total study time to show the retained learning per hour. On the next lesson the system can try different settings for the variables to see if it improves retained learning per hour. The system uses intelligent adjusting of the variables until the right settings are found for that learner in a specific learning condition. Examples of learning conditions include but are not limited to the subject being studied and the difficulty of the subject for the student. For example research done by the inventor has shown that students have different settings for Math vs. English. In addition students have different settings based on how difficult the subject is was for the student to initially understand. For example a second language learner, learning a language intensive subject that is presented in a language that is not their first language has different settings then they have if the subject is not language intensive.

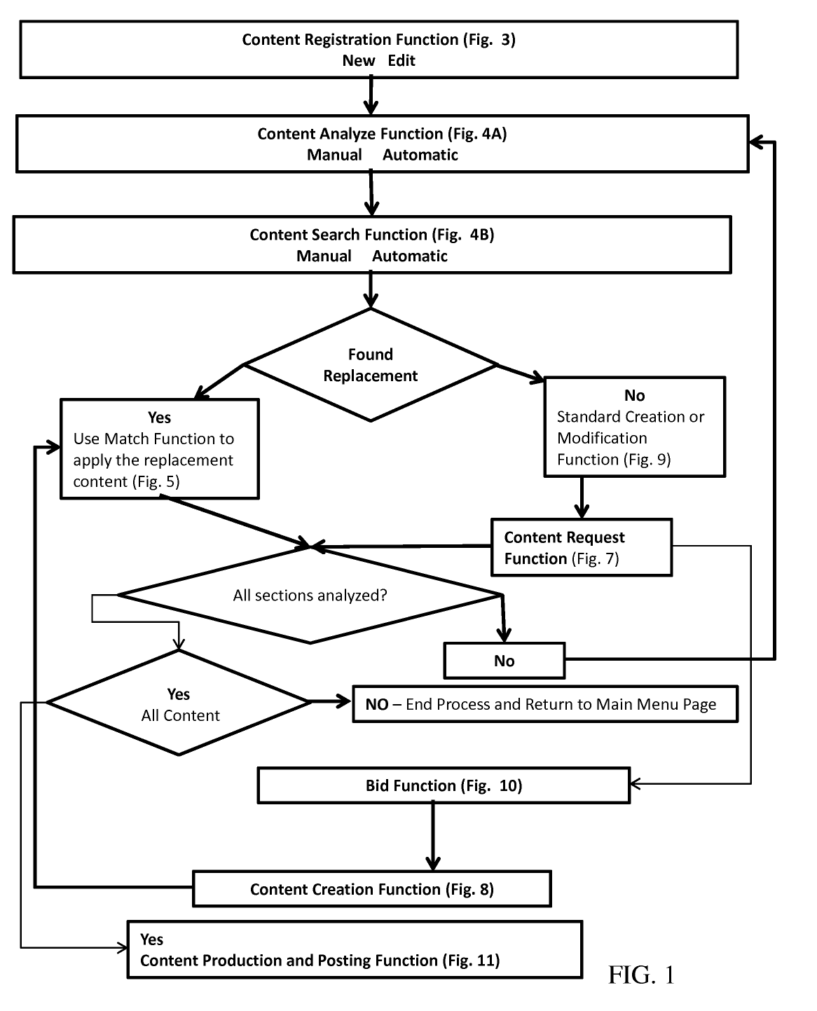

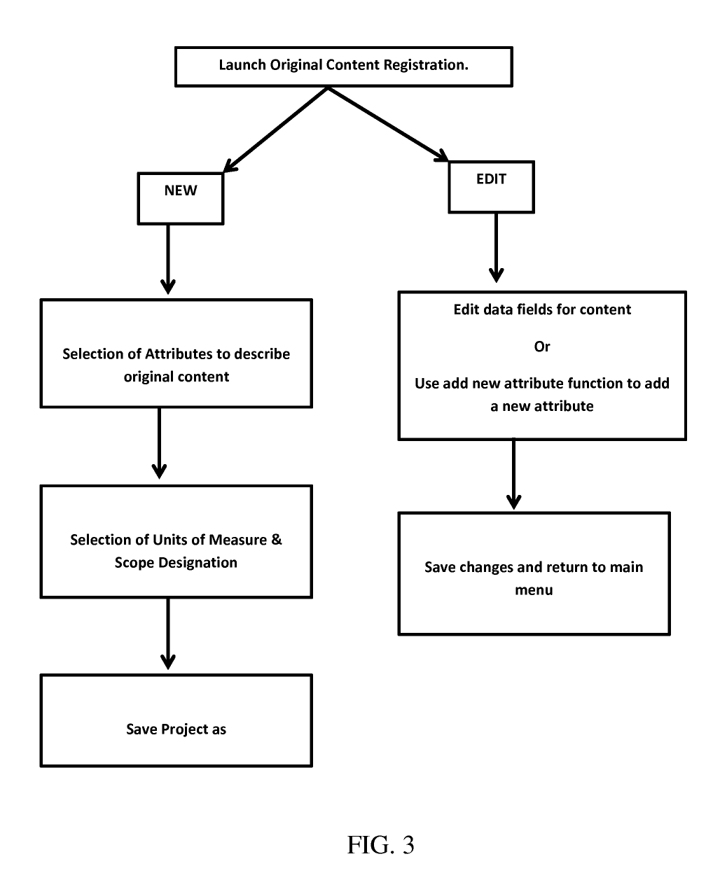

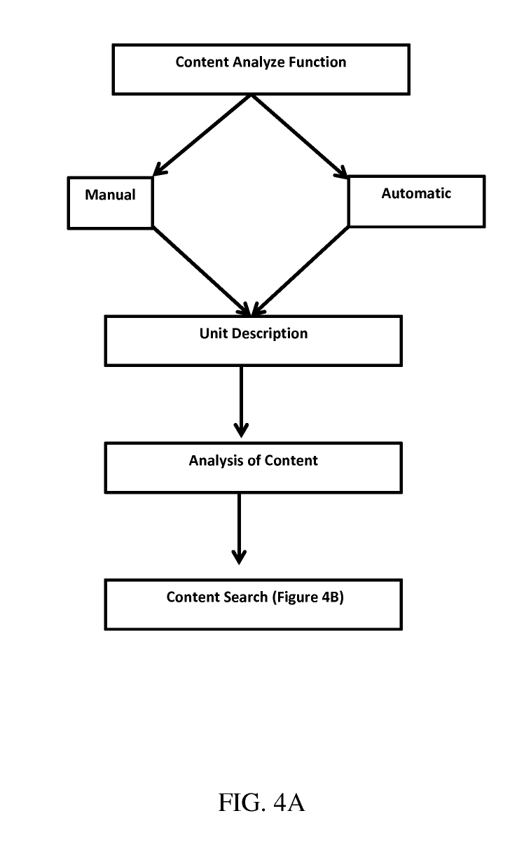

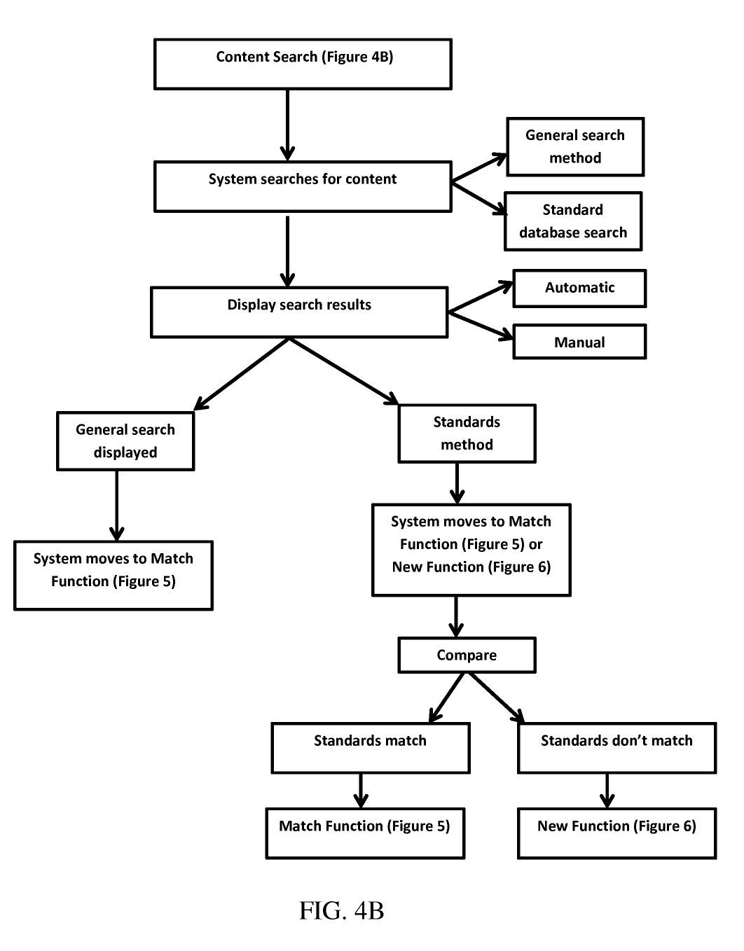

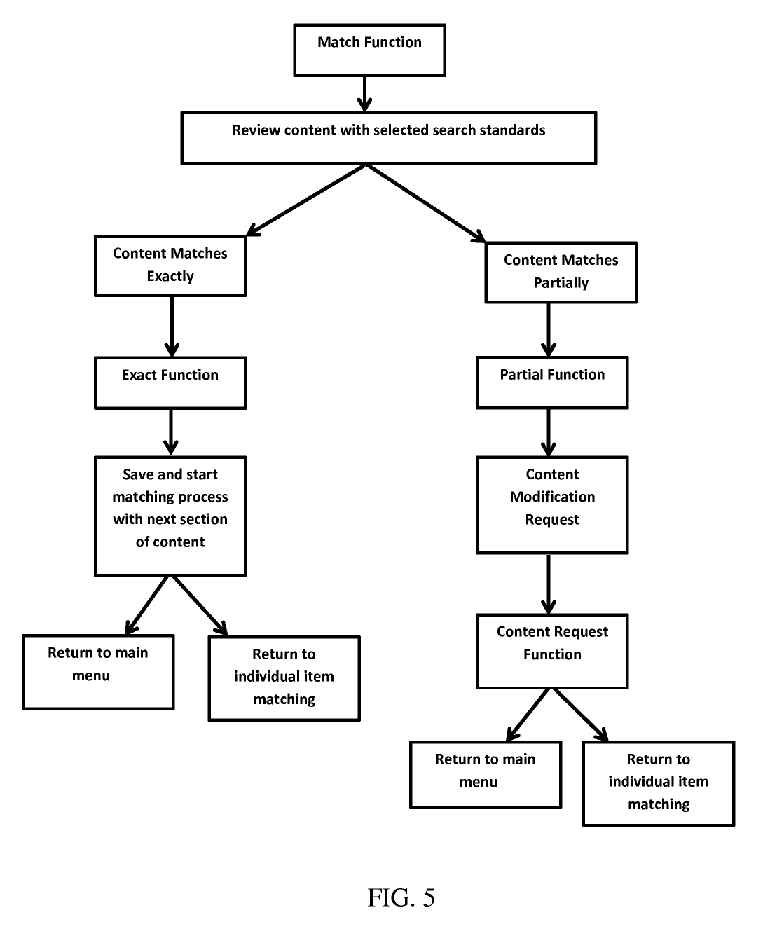

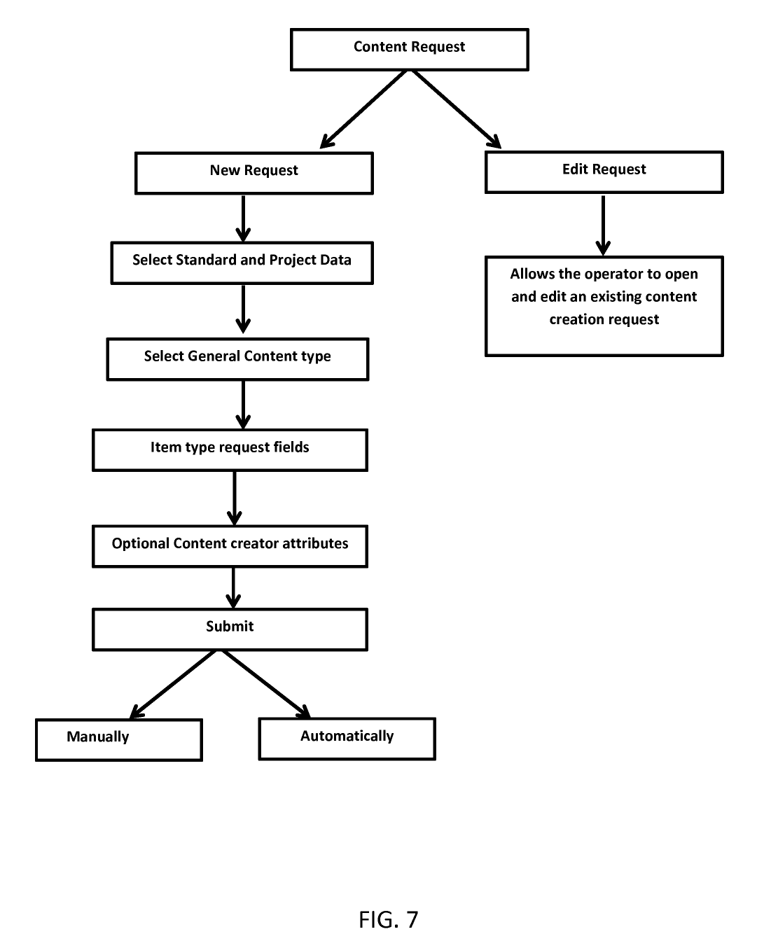

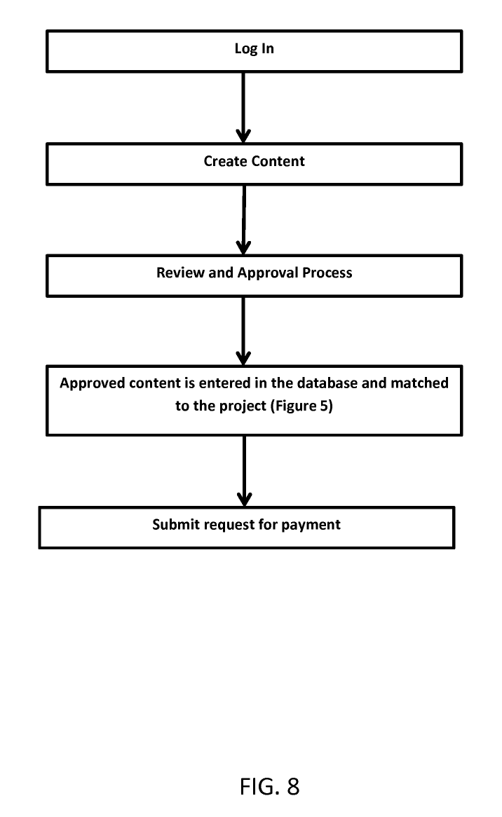

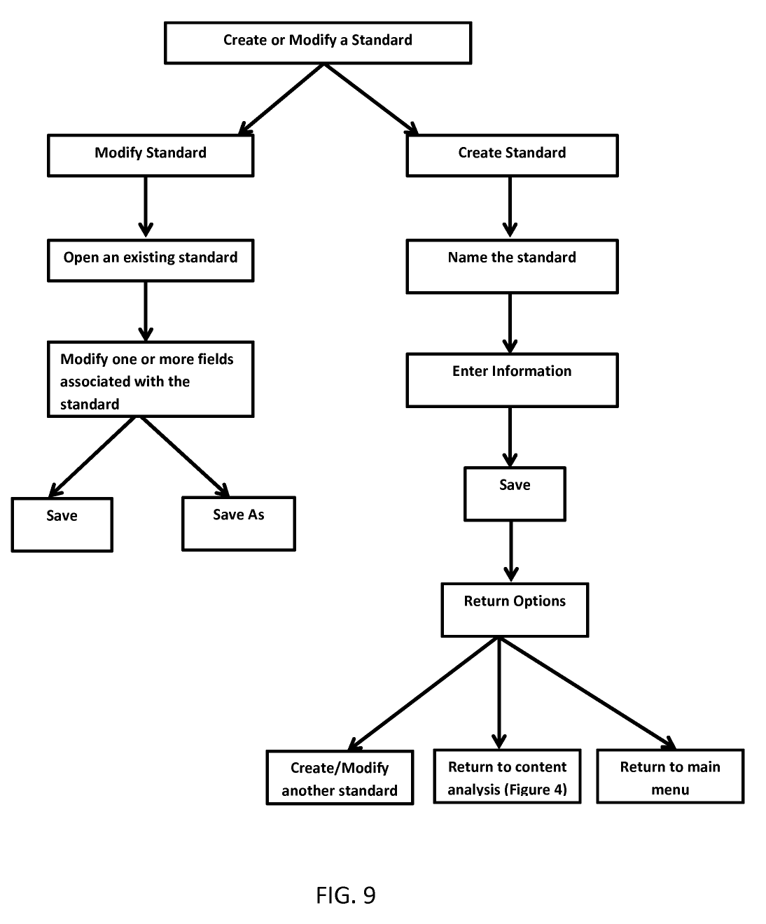

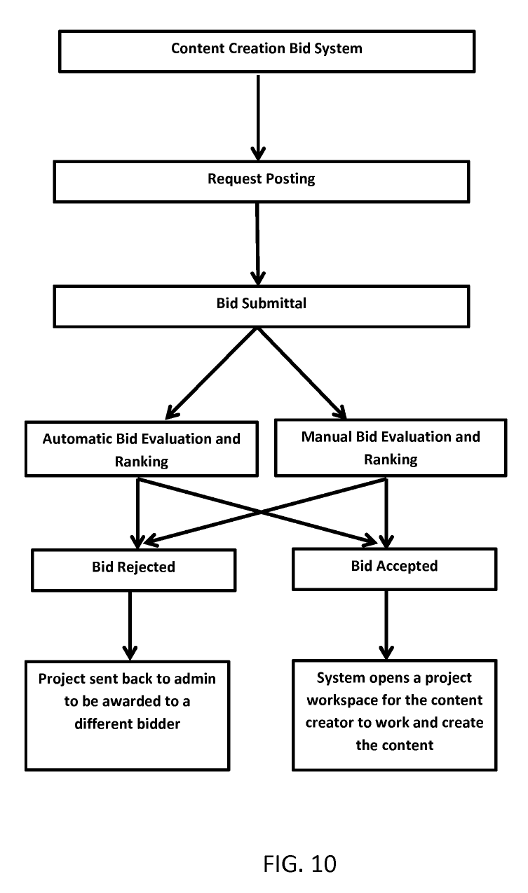

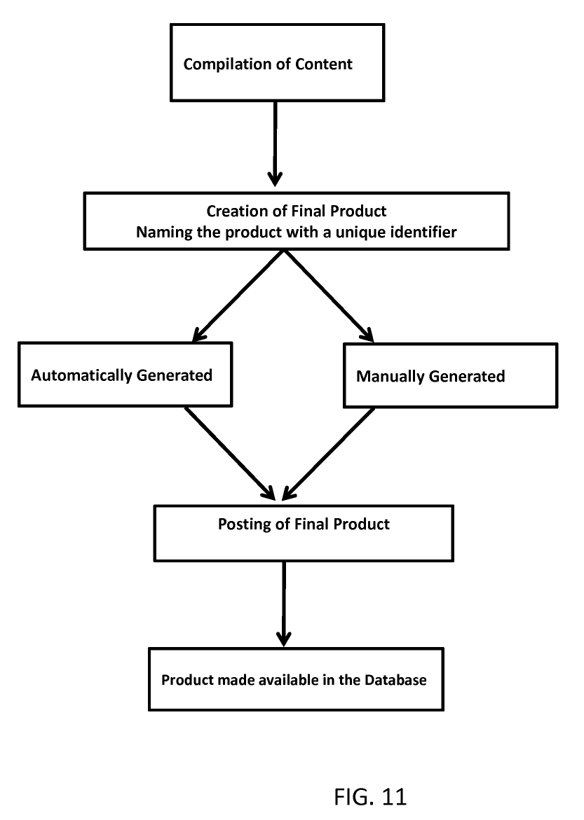

As shown in FIG. 1, the project management and the content creation process of the application for the system, method and apparatus for providing new educational material consists of various steps. Firstly a new project function is opened which allows opening of a new project or edit the data for an existing project which is described in further detail in FIG. 3. Then the original content is analyzed by section either manually or automatically which is further described in FIG. 4A. Then the data is searched for replacement content which is described in further detail in FIG. 4B. Based on the replacement content found further action is taken. So if the replacement content is found the process proceeds to use the match function further described in FIG. 5. If the replacement content is not found the process proceeds to creating or modifying a standard further described in FIG. 9 and further creates a content request described in FIG. 7. Once all sections in the project have been analyzed and all the content has been created the creation and posting of the final product occurs as further described in FIG. 11. If all the sections in the project have not been analyzed and all content has not been created the system ends the process and returns to the main menu. Once the content request is created the process proceeds to the automated content creation bid system further described in FIG. 10 and then the process further proceeds to content creation stage described in FIG. 8.

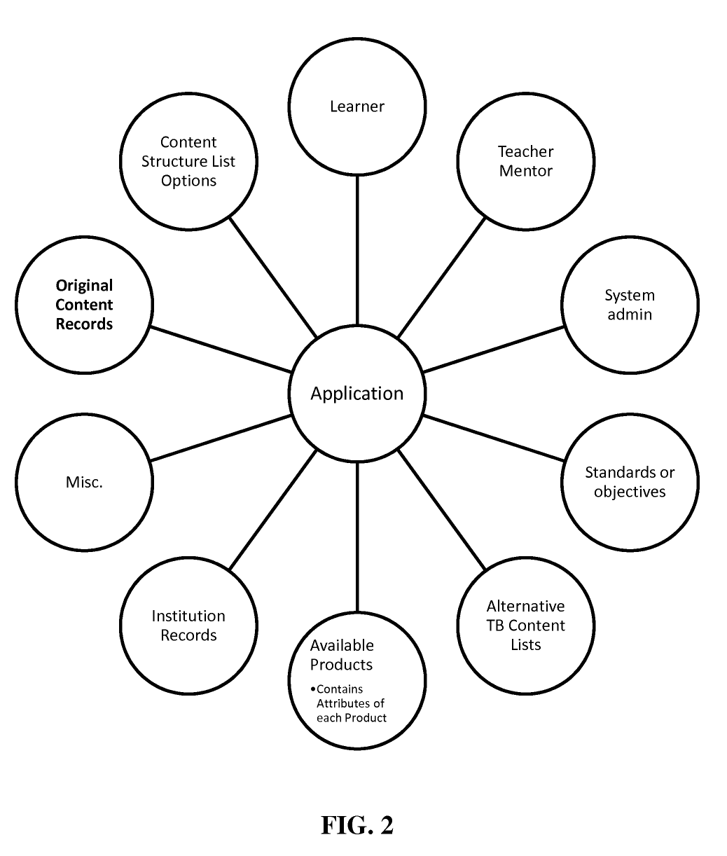

As shown in FIG. 2, the system uses various databases to generate the learning material. The data stored connected to the application includes but is not limited to the data items shown in the figure. The figure is meant for the purpose of showing various aspects of the present disclosure and does not limit the disclosure to one method of data storage or limit the way a specific category of data is stored or used in relation to another category of data.

As shown in FIG. 3, the first step in the process for the system providing new educational material is the Content Registration Function. Once the original content registration window is launched, it allows the user to either search new content or edit already existing content. If the user opts for a new content search, he has to fill out the general details pertaining to the desired content which includes but is not limited to title, author, publisher, publication date etc. A set of existing attributes is further entered to generate the content and if a required attribute doesn't exist use the ‘Add New Attribute’ functions to add the attribute. The various attributes include but are not limited to General subject category (e.g., Math, English, Sales training, project management), Sub-category (e.g., Algebra, Writing strategies, Closing strategies, Annual reviews etc.), Target audience (e.g., Age group, grade level, gender, nationality, profession, language skills, interests etc.). After that save the changes and return to main menu. Saving the changes causes the system to create a new record in the original content database. The record contains all the data from selecting the unit(s) of measure and designating the total scope. The entire scope of the project is designated from beginning to end using the selected unit(s) of measure. For example if a book has 361 pages and page 361 has 31 sentences, then scope start=Page 1 Sentence 1; and Scope End=Page 361 Sentence 31. After the designation of the scope of the entire project is done, the system automatically creates a total scope tracing function which tracks the project and recognizes when new content has been finalized for the total scope and the system automatically generates a final product further described in FIG. 11. If the user opts for editing existing content, the user has the option to edit one or more fields for the content or add a new attribute. Once that is done save the changes and return to the main menu.

As shown in FIG. 4A, after the Content Registration Function the process of the system for providing new educational material proceeds to the next step of Content Analysis Function. The content analysis function allows the user to select an existing project and launches the content analysis function which works manually and automatically. The unit(s) of measure option, mentioned in FIG. 3, is used to select the content to be analyzed. For example from page 5, sentence 1 to page 6, sentence The system assigns a unique identifier and a description of the identifier to this section and stores both in a database. The unique identifier can be but is not limited to a long string of numbers and letters. The description of the identifier identifies where this content is located in the original content. For example if the content was a textbook with 10 pages and the Unit of measure was page and the system created a unit of content for each page, then the information in the content created for page 3 would identify that this section was from page 3. The description of the identifier identifies where this content is located in the original content. The content in the section is analyzed and descriptor items about this content are described. Items might include but are not limited to the specific topics covered; the grade level or reading comprehension level of the content; specific key words, facts or concepts covered. In automatic mode the system Analysis's the data. An example of the way the data is analyzed includes but is not limited to: using Natural Language Processing and key word identification to analyze the content in the section. The analysis identifies the complexity of the sentence and paragraph structure to determine grade level and other data about the section. The system identity's the key parts of the section and uses them to develop search words and phrases. The system then ranks the search terms and search phrases. The system uses imaging processing to analyze any graphics or images and video analysis to analyze video. All this information is entered into the various search fields of the system which is further searched for as described in detail in FIG. 4B.

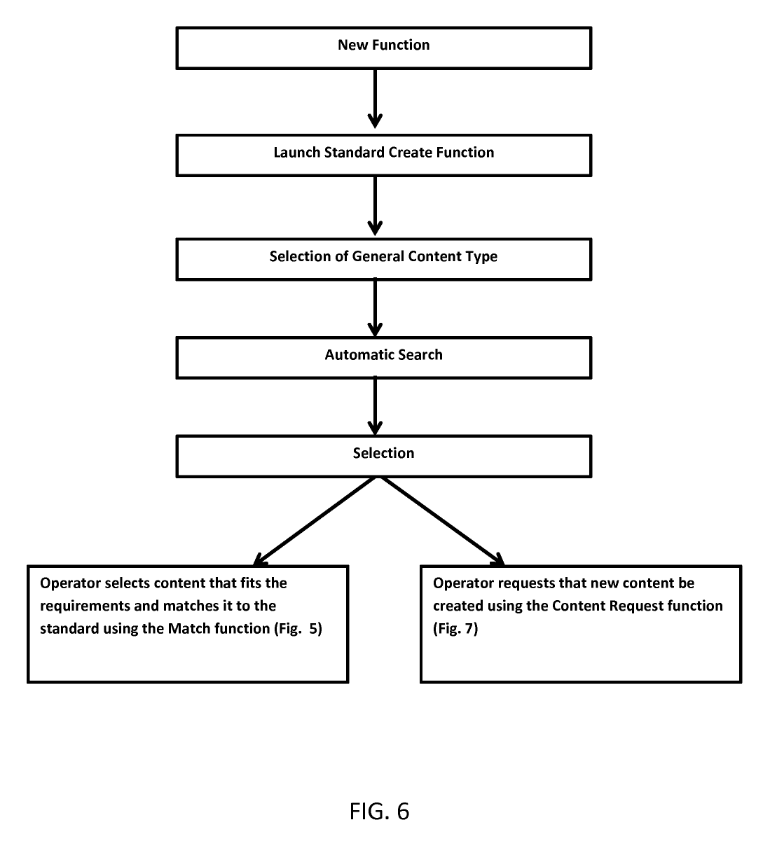

As shown in FIG. 4B, after the Content Analysis Function the process of the system for providing new educational material proceeds to the next step of Content Search Function. The system searches for all available databases. The system works with free form data from any source available to the system. This is called a General Search. As mentioned in the flowchart depending on the settings for the content the system will either search using general search method or search the standards database. The more complex version of the system works with data that is identified by Standards. A Standard that the system can use is any way of describing the content. In the preferred method a Standard is a way of describing content by the outcome that content produces. For example—Students learn how to divide fractions. A Standard has at least two components which are a Name for the standard and a Description of the standard. For clarity purposes (because using Standards is more complex than using general searches) all of the drawings assume that the Standards Based Method is being used. All functions will also work if the General Search method is used. If the general search is being displayed the system moves to match function further described in FIG. 5 and displays the results of the search in the ranked order. If the standards method is used and the system is in the automatic mode the system rates the standards that were identified in the search. If at least one of the standards does not meet the minimum rating threshold for an acceptable match the system launches New Function further described in FIG. 6. If one or more of the standards meets the minimum rating threshold for an acceptable match the system launches the Match Function further described in FIG. 5. If the system is running in manual mode the system ranks the standards and shows them to the operator in ranking order. The operator compares standards selected by the system in the search process and takes the following action. If one or more of the standards are a match the operator selects those standards and clicks the Match function. If none are a match the operator clicks the new function.

As shown in FIG. 5, after the Content Search Function the process of the system for providing the new educational material precedes to the next step i.e. the Match Function. Every standard in the system has existing content associated with the standard. The first step in the content match function is to review the content associated with the standards selected in the search (FIG. 4B) and determine if any one or more items are exact or at least partial match of what is needed to be taught in the selected section. Based on the exact or partial match of the content the operator selects exact function or partial function respectively. If it is an exact match, select content items associated with the standard which is to be presented to the learner as a replacement for the content taught in the selected section of the original content and save and start the matching process with the next section of the original content or return to the main menu. If it is a partial match, select the items that most closely match the content taught in the original content, write a new standard which the system saves in the standard database and associate the selected content with the new standard. The system saves the association between the selected content and the new standard in the database and indicates that the content is not perfect match. Then the content modification request explains how the content needs to be modified to be an exact match for the new standard which describes the selected section of content from the original content. The system saves the request and enters the request into the Content Request Function further described in FIG. 7. Then the system returns to main menu of FIG. 1 or returns to individual item matching of FIG. 4.

As shown in FIG. 6, after the Match Function the process of providing the new educational material precedes to the next step i.e. the New Function. Once the new function opens it launches the Standard create function. Then the system automatically populates the relevant fields of the standard creation form with information about the project (mentioned in FIG. 3) along with the descriptor items (mentioned in FIG. 4). The operator then selects the general content types further described in FIG. 7 for information on general content types and initiates the automatic search. The system uses information entered by the operator to search for content that might match the requirements. The places the system searches can include but are not limited to the internet and other sources of existing content, the system databases of existing content. The operator selects any content that fits the requirements and matches it to the standard using the Match Function described in FIG. 5. The operator uses the content request function described in FIG. 7 to request that the new content be created.

As shown in FIG. 7, after the New Function the process of providing new educational material proceeds to the next step i.e. Content Request Function wherein the user can request new content or request edit content. The user can select standard and existing project and the specific section of a project that the new content will be used for. Then the user is shown general content types that include but are not limited to: assessment questions, lessons, assignments, study session questions etc. For each selected general item, the Operator fills out fields that provide details that the content creator will use to create the right type of content. For example the detail on a lesson request may specify that the lesson be provided in the form of a video as opposed to text. The user also has an option to select the attributes that content creators must have to work on this request. For example the user may select the attribute that they must be credentialed Math Teachers. Once the request fields are filled out along with the optional attributes it is submitted to the system to combine information in the requested item fields with the project data and posts the information in the content creation function further described in FIG. 8 to create an official content creation request. The submission can be done using manual or automatic option. If the submit/manual option is selected the request is sent to a specific content creator or to an administrators dashboard that allows the administrator to decide who should create the content. The user can select a specific creator or the send to administrator option. The Administrator has the ability to review the request and assign it to a specific creator(s) or to the automated system further described in FIG. 10. If the submit/automatic option is selected the request is automatically posted by the system to the content bid system further described in FIG. 10.

FIG. 8 shows the Standard Creation or Modification Function and the site for the application of the system and method for providing new educational material. The user has to log in to the project workspace and use the tools on the website to either select create content or import content option. The tools for creating content can include but are not limited to 1) Tools for writing, laying out and editing lessons, 2) Tools for creating Question related items like: Tests, Study Sessions and surveys, 3) Tools for creating audio, video and other media, 4) Tools for searching and importing content, 5) Tools for creating items from templates where the templates can include: Simulation, Assignments, Forms etc. Once the content is created it is submitted for review and approval and changes are made if requested by administrator and resubmitted for review and approval. These steps are repeated until the content is finally approved. Approved content is automatically entered into the content database and matched to the project as described in FIG. 5. Once the content is approved the content creator can use the system to submit a request for payment or the system can automatically submit the request for payment. Requests for payment are sent to accounting where they are approved and paid.

FIG. 9 shows the Content Creation/Modification Function of the system and method for providing new educational material. As shown in FIG. 1, if the replacement content is not found the system enters the Content Creation/Modification Function of FIG. 9. If the user chooses the modification of content, it opens an existing standard and allows modifying one or more of the fields associated with the existing standard which is then saved. There are two kind of save options wherein ‘save’ allows to saves changes without changing the name of the standard and ‘save as’ allows the operator to change the name and save all the data as a new standard. The system shows return options such as create/modify another standard, return to content analysis as described in FIG. 4 and return to main menu. If the user chooses the creation of content, the name of the standard to be created is to be entered or a name is selected to be from an existing list. Further information is entered to open relevant data fields for a new standard. The user enters or selects the information for each field wherein the data fields include but are not limited to: 1) General subject Category (e.g. Math, English, Sales Training, Management), 2) Sub-Category (e.g. Algebra, Writing Strategies, Closing strategies, annual reviews), 3) Target Audience (e.g. Age group, Grade level, Gender, Nationality, Profession; Language skills, Interests, Special needs), 4) Key Words and phrases etc. The content created is then saved and the system shows returns options such as create/modify another standard, return to content analysis as described in FIG. 4 and return to main menu.

The system and method for providing new educational material enters the Bid Function of FIG. 10 after the Content Request Function described in FIG. 7. Once the content creation bid function is entered the system automatically posts notices about content creation requests to one or more sites. Notices can include but are not limited to: the information from the content creation request system, date the content is needed by, due date for bids etc. Then individual or companies submit bids to do the content creation job. Bids can include but are not limited to: information about the bidder, time required to complete the job, the experience level of the content creator(s), the bid price etc. The bid can be evaluated and rewarded automatically by the system or manually by the administrator. In automatic bidding the system automatically evaluates the bids according to a rating scale which is determined by a list of rated items. The rated items can include but are not limited to: bidders' experience, the quality rating of content previously submitted by that bidder, the bid price etc. Each item on the list of rated items has a point value and the scale is made up of the accumulation of the scores the bid receives on each rated item based on which the system evaluates the bids and assigns a total score to each bid. Then the system produces a report where all the bids are ranked in order of points earned and the system can be programmed to automatically assign the project to the bidder with the highest points. The system launches the bid process and collects bids for the development of the content on the content request. Once the winning Bid is accepted, the system opens a content creation workspace. Whereas in manual bidding the administrator opens the bid review functionality and selects a bid request to review wherein the system shows the administrator the bids in ranked order. The administrator can further request more information from one or more bidders if needed or can also reject all bids and restart the request posting process. The administrator can award the bid to any of the bidders who can either accept or reject the project. If the bidder rejects the project it is sent back to the manager's review panel to be awarded to a different bidder. If the bidder accepts the project the system opens a project workspace on the system and the content creator uses the workspace and the system content creation tools to create the content as described in FIG. 8.

As shown in FIG. 11, once the content is created the system and method for providing new educational material proceeds to the next step of Content Production and Posting Function. The content is then compiled using the unique identifier and the description of the unique identifier to organize the replacement content in the same sequential order as the original content. The final product with a unique identifier is then given a name either automatically or manually. The final product is then either finally approved by the administrator before posting or posted directly and made available in the database. Once the final product is posted to the available products database, various retail, e-commerce and other means can be used to assign the product to an individual or groups of learners.

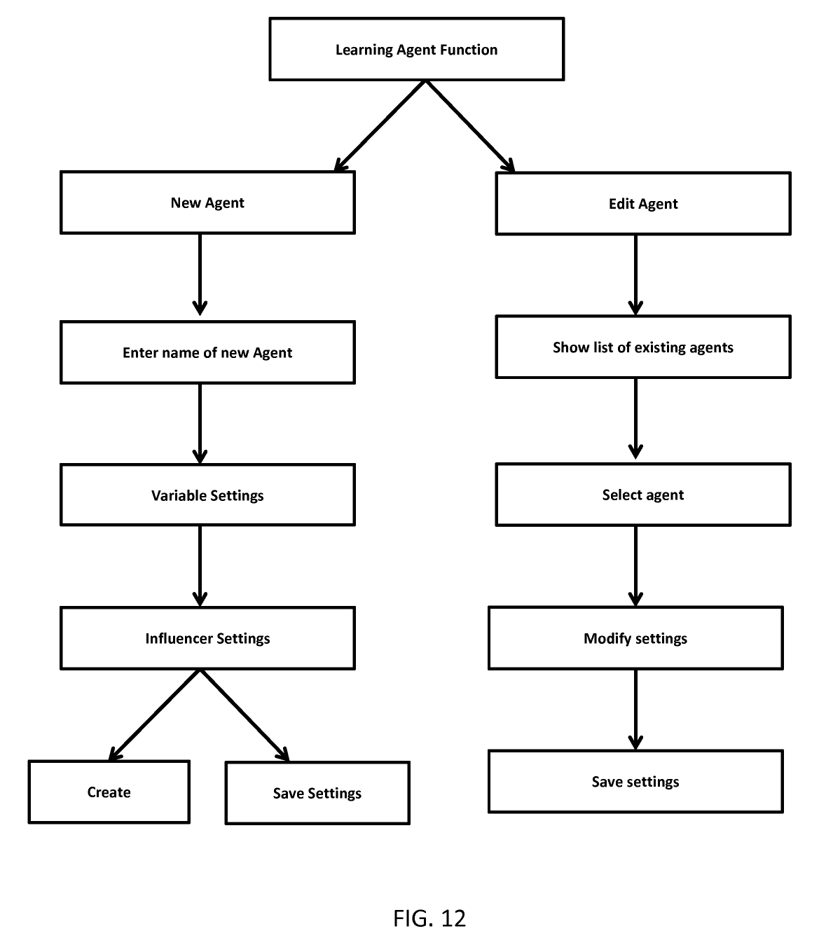

As shown in FIG. 12 the system and method for providing a learning method has a Learning Agent Entry Function. In this function either a new learning agent is selected or an existing learning agent is edited. For a new learning agent the name of the new learning agent is entered and variable settings are selected and applied. The setting range for each selected variable is picked from the available variables list and other program modifiable characteristics are entered. The influencer settings are selected from a list of available influencers or by creating a new influencer, further a setting range for each influencer is selected. Further by opting for the save setting the user can save the selected setting but does not build or apply the agent whereas the create option builds and applies the new learning agent. For editing an existing learning agent the administrator selects a learning agent from the list of existing agents and the system opens a settings window that the administrator can use to modify and save the settings.

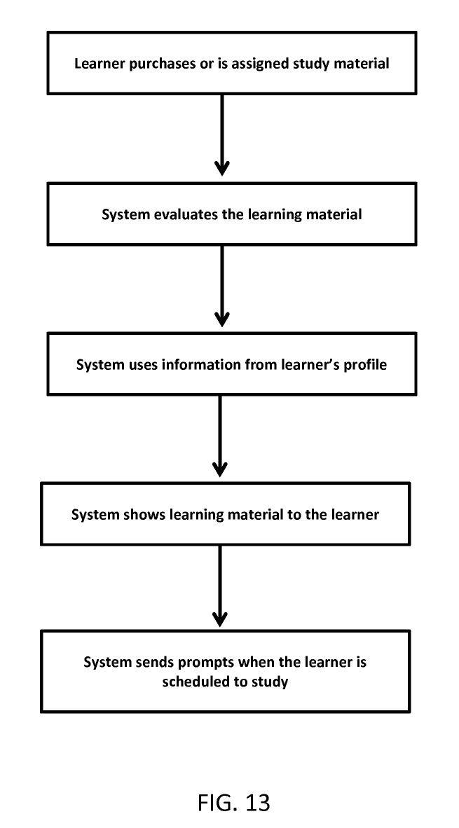

As shown in FIG. 13, the system and method for providing new educational material has a Study Schedule Function. In this function the content for the study schedule of an individual learner is generated. First the learner purchases or is assigned a learning material. Then the system evaluates the length of the educational material to be studied and the other user entered data like length of the time the learner has to learn the educational material and the dates the learner wishes to take tests on the material. Based on the information in the learner's learning and study profile the system creates a schedule for the learners. The learner's study schedule includes but is not limited to the dates the learners should study, what should be studied on each date etc. The system shows the learning and study schedule to the learner and sends prompts to the learner on days when the learner is scheduled to study

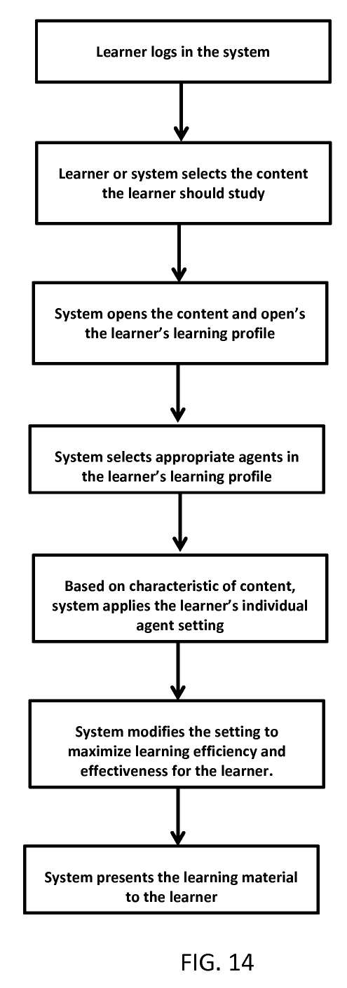

FIG. 14 shows, the Content Presentation Function of the system and method for providing the learning material. When the learner first log into the system the learner or system selects the content the learner should study. This could be lessons that present new content or study sessions that reactivate memories for content that was taught to the learner in a previously presented lesson. The system opens the content and opens the learner's learning profile. The system selects the appropriate agents in the learner's learning profile based on the characteristics of the content and applies the learner's individual agent setting to modify the learning experience to maximize learning efficiency and effectiveness for the learner.

For example a learning agent can store information about how well a learner did at answering a set of study questions on a topic and use this information to determine when the learner should restudy that topic. In addition the agent can track the difficulty level of the questions that the learner was able to answer correctly and the difficulty level of the questions that the learner answered incorrectly when studying a specific topic. Then the next time the learner studies this topic that information can be used to increase the difficulty of the questions related to the topics that the learner answered correctly while keeping the difficulty level the same for questions that the learner did not answer correctly. In another example when the system stores two or more content objects that teach the same subject the agent can use stored characteristics about the learner to determine which of the content objects will produce the best learning outcomes for the learner.

In one embodiment of the present disclosure, a system and method for providing individuals with a viable and improved alternative to a specific textbook or similar educational product is provided. The method includes 1) analyzing a book or similar educational product page by page or section by section in order to create a list of the content taught in each page or section which, for the purposes of this disclosure, shall be called the original content list, this content includes but is not limited to facts, concepts, formula, ideas, and skills 2) creating new educational material that teaches the items on the original content list without violating any copyright laws.

In another embodiment of the present disclosure, a system and method for providing individuals with a viable and improved alternative to a specific textbook or similar educational product is provided. The method includes 1) analyzing a book or similar educational product page by page or section by section in order to create a list of the content taught in each page or section which, for the purposes of this disclosure, shall be called the original content list, this content includes but is not limited to facts, concepts, formula, ideas, and skills 2) creating multiple new educational materials that teaches the items on the original content list without violating any copyright laws. Saving characteristics related to learning about that material such that a system can use information about an individual learner to select the best one of the multiple educational materials stored for an item on the content list to present to that individual learner.

In another embodiment of the present disclosure, a method for providing individuals with a learning material, the method including 1) analyzing a book or similar educational product, 2) creating new educational material that teaches the items taught in the specific textbook or similar educational product without violating any copyright laws, 3) Creating the new educational material in a way that reduces the cost of creating the new educational material by such an extent that a viable business can be created to sell learning material as an alternative to the textbook or similar educational product.

In yet another embodiment of the present disclosure, a method for providing individuals with a new educational material wherein the method includes 1) analyzing a book or similar educational product page by page or section by section in order to create a list of the content taught in each page or section which, for the purposes of this disclosure, shall be called the original content list, this content includes but is not limited to facts, concepts, formula, ideas, and skills 2) creating new educational material that teaches the items on the original content list without violating any copyright laws, 3) Creating the new educational material in a way that reduces the cost of creating the new educational material by such an extent that a viable business can be created to sell alternatives to the textbook or similar educational product, 4) creating additional content items that help the student study the new educational material, 5) personalizing the presenting of the new educational material to each learner in a way that improves learning efficiency and learning outcomes for that learner.

In yet another embodiment of the present disclosure, a method for providing individuals with a new educational material, the method including 1) analyzing a book or similar educational material page by page or section by section in order to create a list of the content taught in each page or section which, for the purposes of this disclosure, shall be called the original content list, this content includes but is not limited to facts, concepts, formula, ideas, and skills, 2) creating new educational material that teaches the items on the original content list without violating any copyright laws, 3) creating additional content items that help the student study the alternative content, 4) personalizing the presenting of the new educational material to each learner in a way that improves learning efficiency and learning outcomes for that learner, 5) using a content acquisition and creation strategy that reduces the cost of creating the learning material.

In yet another embodiment of the present disclosure, a method for providing individuals with a learning material, the method including 1) analyzing a book or similar educational material page by page or section by section in order to create a list of the content taught in each page or section which, for the purposes of this disclosure, shall be called the original content list, this content includes but is not limited to facts, concepts, formula, ideas, and skills, 2) creating new educational material that teaches the items on the original content list without violating any copyright laws, 3) creating additional content items that help the student study the new educational material, 4) personalizing the presenting of the new educational material to each learner in a way that improves learning efficiency and learning outcomes for that learner, 5) creating a list of pre-requisite knowledge that the student should possess in order to understand the learning material, 6) creating content to teach these pre-requisite items and content to aid the student in studying these prerequisite items, 7) using the assessment items to assess a student's understanding of the pre-requisite items, 8) using the result of the assessment to determine which if any of the prerequisite content items and study items to be presented to the learner and then presenting those items to the learner.

In yet another embodiment of the present disclosure, a method for providing individuals with a learning material, the method including 1) analyzing a book or similar educational product page by page or section by section in order to create a list of the content taught in each page or section which, for the purposes of this disclosure, shall be called the original content list, this content includes but is not limited to facts, concepts, formula, ideas, and skills, 2) creating new educational material that teaches the items on the original content list without violating any copyright laws, 3) creating additional content items that help the student study the alternative content, 4) personalizing the presenting of the new educational material and the study content to each learner in a way that improves learning efficiency and learning outcomes for that learner, 5) building and updating a learning profile on the learner, 6) using this learning profile to determine the best methods to use to teach new content to the learner and the best methods and scheduling to use for presenting learning material to the learner in the remainder of this alternative book and future alternative books.

In yet another embodiment of the present disclosure, a method for providing individuals with a new educational material wherein the method includes 1) analyzing a book or similar educational product page by page or section by section in order to create a list of the content taught in each page or section which, for the purposes of this disclosure, shall be called the original content list, this content includes but is not limited to facts, concepts, formula, ideas, and skills, 2) creating new educational material that teaches the items on the original content list without violating any copyright laws, 3) creating additional content items that help the student study the alternative content, 4) personalizing the presenting of the new educational material to each learner in a way that improves learning efficiency and learning outcomes for that learner, 5) Creating a lecture note taking guide that is available electronically or can be printed out. A guide that allows the student or the system to identify items that are more likely to be covered on a test with the system using this information to build a program of study that puts more emphasis on the items that have been identified as more likely to be covered on the test over items that are not identified as likely to be covered on the test.

In yet another embodiment of the present disclosure, a method for providing individuals with a learning material, the method including 1) analyzing a book or similar educational product page by page or section by section in order to create a list of the content taught in each page or section which, for the purposes of this disclosure, shall be called the original content list, this content includes but is not limited to facts, concepts, formula, ideas, and skills, 2) creating new educational material that teaches the items on the original content list without violating any copyright laws, 3) creating additional content items that help the student study the alternative content, 4) personalizing the presenting of the new educational material to each learner in a way that improves learning efficiency and learning outcomes for that learner, 5) use a personalized cataloging system to keep track of everything the learner has ever learned 6) uses a system to identify when the learner needs to use information in the catalog again and represents the alternative lesson and study material to the learner for re-learning or for another purpose like writing a paper.

In yet another embodiment of the present disclosure, a method for providing individuals with a learning material wherein the method includes 1) analyzing a book or similar educational product page by page or section by section in order to create a list of the content taught in each page or section which, for the purposes of this disclosure, shall be called the original content list, this content includes but is not limited to facts, concepts, formula, ideas, and skills, 2) creating alternative content that teaches the items on the original content list without violating any copyright laws, 3) creating additional content items that help the student study the alternative content, 4) personalizing the presenting of the learning material to each learner in a way that improves learning efficiency and learning outcomes for that learner, 5) Create assessment questions on the alternative content 6) use the assessment items to assess the learner and delete items from the new educational material list that the learner already knows.

In an alternative embodiment of the present disclosure the educational material is provided using a reading system that accelerates reading speeds or an immersive media system that increases the one or more learner's comprehension.

In yet another aspect of at least one embodiment the one or more learners decide which format to receive the educational material.

In yet another aspect of at least one embodiment the system stores information about the one or more learners or information about the device the one or more learner is using to determine the format to receive the educational material.

In yet another aspect of at least one embodiment the system and method for providing new educational material is programmed with many different variables that can be changed to modify the learning experience to fit the needs of each learner and demands of each item of content in the system. Additional variables can also be added from time to time as needed.

In one aspect of at least one embodiment the system and method for providing new educational material includes learning and study agents can be programmed into a system using the learning and study agent system or they can be entered at the program code level. A learning or study agent is a feature that can be varied by the the learner or by the content that affects the learning outcome. For example each learner has different ideal setting for the number of days to skip between learning new educational material and studying that material and the number of days between the first and each subsequent time the learner studies the material. Presenting the new educational material exactly on this schedule dramatically increases the learning efficiency and learning outcomes as measured by test scores.

In yet another embodiment the system and method for providing new educational material uses information about the learner and provided by the learner to determine the starting settings for each learner. As the learner uses the system to learn and study, the system varies the settings and monitors the change in the relevant learning outcome. The main learning outcome is retained learning per hour of study (RLH). This is measured by the difference between a pre-test score (PRT) and post-test score (POT) divided by the total time the learner spends studying the material covered on the tests (TT), i.e. RLH=(POT−PRT)/TT. The system continues to modify the variables until the ideal setting is determined for that learner.

In one aspect of at least one embodiment the system and method for providing new educational material includes a learning profile for one or more learners that stores many different sets of ideal settings for each learning or study agent. This is needed because there are different influence items that affect the ideal setting. The system can store one or more influence item for each agent. An example of the influence item that affects the ideal spacing between study sessions is the subject matter of the content. Learners have a different ideal spacing for Math and English. If subject is entered into the influence item list the system will determine an ideal setting for each subject. Examples of influence item include but are not limited to: the learner's pre-test score, the learner's age, grade level, the subject matter of the content, the language level of the learner, the learner's reading comprehension ability, the learner's working memory capacity etc. Once the settings for a learning or studyagent are determined they are stored in the learner's learning profile. The system uses these settings with all future content. Thus when the learner uses one product in the system similar modifications are applied to other products of the system.

Among other things, the methods and systems of the present disclosure provide a better learning experience for the learner when compared to the original educational material (e.g., textbook), putting competitive pressure on publishing and textbook companies to improve their product, which is good for individuals and the entire education system. It should be appreciate that the systems and methods of the present invention can be accomplished through known computer networks, servers and computers.

While the systems and methods have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method of providing new educational material to one or more learners, the method comprising:
analyzing the words or images used in one or more items of original educational material to determine the topics covered in the original educational material;
identifying the topics covered in the original educational material;
identifying the order in which the topics are presented in the original educational material;
creating a list of the topics covered in the original educational material and the order in which they are presented;
searching available databases and publically known sources for content on the topics covered in the original educational material;
compiling the content on the topics covered in the original educational material to create a new educational material that covers the topics of the original educational material; and
providing or providing access to the new educational material to one or more learners;
wherein the characteristics of the one or more learners are used to modify the presentation of the new educational material and to improve the learning experience for the one or more learners.

2. The method of claim 1, further comprising receiving from the one or more learners information regarding the format to present the new educational materials.

3. The method of claim 1, further comprising using stored information regarding the one or more learners to determine the best format to present the new educational materials.

4. The method of claim 1, wherein the order of topics presented in the new educational material is at least substantially similar to the order of the topics presented in the original educational material.

5. The method of claim 1, wherein the new educational material is presented as any combination of audio, video, text and images.

6. The method of claim 1, further comprising creating a list of pre-requisite educational material that the one or more learners should possess in order to understand the new educational material.

7. The method of claim 6, further comprising assessing the one or more learner's knowledge of the pre-requisite educational material and determining which if any of the prerequisite educational material to be presented to the one or more learners and presenting the prerequisite educational material to the one or more learners on various types of devices.

8. The method of claim 1, further comprising identifying and updating the new educational material the one or more learners learn.

9. A method of providing new educational material to one or more learners, the method comprising:
analyzing the words or images used in one or more items of original educational material to determine the topics covered in the original educational material;
identifying the topics covered in the original educational material;
identifying the order in which the topics are presented in the original educational material;
creating a list of the topics covered in the original educational material and the order in which the topics in the original educational material are presented;
posting bid requests for creating the new educational material;
evaluating the bid requests for creating the new educational material; and
awarding the bid to one or more bidders for creating the new educational material.

10. The method of claim 9, wherein the bid is evaluated on one or more factors including: time required to complete the job, the experience level of the creator(s) of the educational material, the bid price.

11. A system of creating new educational material provided to one or more learners, the method comprising:
analyzing the words or images used in one or more items of original educational material to determine the topics covered in the original educational material;
identifying the topics covered in the original educational material;
identifying the order in which the topics are presented in the original educational material;
creating a list of the topics covered in the original educational material and the order in which the topics in the original educational materials are presented;
searching available databases and publically known sources for content on the topics covered in the original educational material;
compiling the content on the topics covered in the original educational material to create a new educational material that covers the topics of the original educational material; and
providing or providing access to the new educational material to one or more learners;
wherein characteristics about the one or more learners are used to modify the presentation of the new educational material to improve the learning experience for the one or more learners.

12. The system of claim 11, further comprising receiving from the one or more learner information regarding the format to present the new educational materials.

13. The system of claim 11, further comprising using stored information about the one or more learners to determine the best format to present the new educational materials.

14. The system of claim 11, wherein the new educational material is presented as any combination of audio, video, text and images.

15. The system of claim 11, further comprising creating a list of pre-requisite educational material that the one or more learners should possess in order to understand the new educational material.

16. The system of claim 11, further comprising assessing the one or more learner's knowledge of the pre-requisite educational material and determining which if any of the prerequisite educational material to be presented to the one or more learners and presenting the prerequisite educational material to the one or more learners on various types of devices.

17. The system of claim 11, further comprising identifying and updating the new educational material the one or more learners learn.

18. The system of claim 11, wherein the system works on an internet enabled device or networked computers.

19. The system of claim 18, wherein the internet enabled device or networked computers are connected to servers or main frame computers that contain the various application programs and database programs.

20. The system of claim 18, wherein the internet enabled device or networked computers is from a group consisting of: desktop computers, laptop computers, netbook, terminal, iPad, tablets, immersive learning devices, virtual reality devices and smartphones.
